(19) United States
(12) Patent Application Publication
(10) Pub. No.: US 2008/0185388 A1
(43) Pub. Date: Aug. 7, 2008

(54) Non-soot pot

(76) Inventor: Jingao Hu, Yongkang City (CN)

Correspondence Address: BIRCH STEWART KOLASCH & BIRCH, PO BOX 747, FALLS CHURCH, VA, 22040-0747, US

(21) Appl. No.: 11/790,867

(22) Filed: Apr. 27, 2007

(30) Foreign Application Priority Data
Feb. 1, 2007 (CN) 200710067167.X

(51) Int. Cl. A47J 27/00

(52) U.S. Cl. 220/573.2

(57) ABSTRACT

The invention provides a non-soot pot, comprising pot body. The pot further comprises the even thermal layer with the lower thermal conductivity than that of the pot body located on the inner surface of the pot body. The aluminum alloy or magnesium alloy with higher thermal conductivity is used as pot body for rapid heating in the present invention and the Zhisha ceramic with lower thermal conductivity or stainless steel is sintered or compounded as even thermal layer on the inner surface of the pot body again. The local high temperature in the pot body will be dispersed to the whole even thermal layer so as to no local high temperature in the pot body, no soot and save energy. Some tiny convex structures are provided on even thermal layer with air in the cavity between them. After heating the air expands so as to separate food from the pot body and achieve the physical nonstick effect. This physical nonstick structure can achieve better nonstick effect than the original chemical coating. The external surface of the pot body is spiral structure which increases the surface area and improves the utilization of energy.

### TECHNICAL FIELD

The present invention relates to a kitchenware, more particularly to an even thermal, nonstick and non-soot pot.

### BACKGROUND ART

When cooking, the flame is used for heating the pot body. For the part of pot body near the flame, its temperature is higher, while the temperature is lower for that away from the flame. The local high temperature on the pot body will cause the cooking oil have soot which not only seriously endanger the people's health, make people be fatter, and induce various diseases, but also affect the facial skin to make people aging easily.

Sticking to the pot when cooking is also a major drawback of the frying pot. For this some manufacturers add an organic nonstick coating on the inner surface of the pot body to resolve the problem. This organic nonstick coating will decompose out bad substance that will be harmful to the human body when encountered high temperature, and also peels off easily after used for a period of time. Meanwhile, the external surface of the pot is smooth, without concave-convex structures, which can make the heating area limited and can not fully utilize the energy.

### DISCLOSURE OF INVENTION

An object of the present invention is to solve the problems of the prior art, and provide a non-soot pot in which the temperature is even, no local high temperature and no soot is produced when cooking, then the energy is saved.

To achieve the above object, the present invention provides a non-soot pot, comprising pot body, further comprising the even thermal layer located on the inner surface of the pot body with the lower thermal conductivity than that of the pot body.

Preferably, the bottom of the pot body is thick and the edge is thin.

Preferably, the whole pot body is 1-6 mm in thickness, the bottom and the edge in thickness is 3-6 mm and 1-3 mm respectively.

Preferably, the pot body is made of aluminum alloy or magnesium alloy material, on the inner surface of which Zhisha ceramic is sintered as the even thermal layer.

Preferably, the pot body is made of aluminum alloy or magnesium alloy material, on the inner surface of which the stainless steel is compounded as the even thermal layer.

Preferably, the external surface of the pot body is the spiral structure.

Preferably, some tiny convex structures are provided on the even thermal layer.

Preferably, the convex structure is radial convexity or spiral convexity.

The advantageous effects of the present invention are as follows: the aluminum alloy or magnesium alloy with higher thermal conductivity is used as pot body for rapid warming in the present invention and the Zhisha ceramic with lower thermal conductivity is sintered or stainless steel is compounded as even thermal layer on the inner surface of the pot body again. The local high temperature in the pot body will be dispersed to the whole even thermal layer so as to produce no local high temperature, no soot and save energy in the pot. Because the thermal conductivity of the inner layer of the even layer is relatively lower than that of the pot body, the local high temperature in the pot body is obstructed and dispersed evenly to the even thermal layer, the high temperature and soot are avoided. Some tiny convexity structures are provided on even thermal layer with air in the cavity between them. After heating the air expands so as to separate food from the pot body and achieve the physical nonstick effect. This physical nonstick structure can achieve better nonstick effect than the original chemical coating. The external surface of the pot body is spiral structure which increases the surface area and improves the utilization of energy.

The characteristics and advantages of the present invention will be specifically described through the examples combined with the attached drawings.

### DESCRIPTION OF THE DRAWINGS

FIG. 1 shows schematically section view for the structure of non-soot pot in the present invention.

FIG. 2 is a schematic section view of the embodiment 1 for the convexity structure on the even thermal layer of the non-soot pot according to the present invention.

FIG. 3 is a schematic section view of the embodiment 2 for the convexity structure on the even thermal layer of the non-soot pot according to the present invention.

FIG. 4 is a schematic section view for the spiral structure of the non-soot pot external surface according to the present invention.

### EMBODIMENT MODE FOR CARRYING OUT

### Embodiment 1

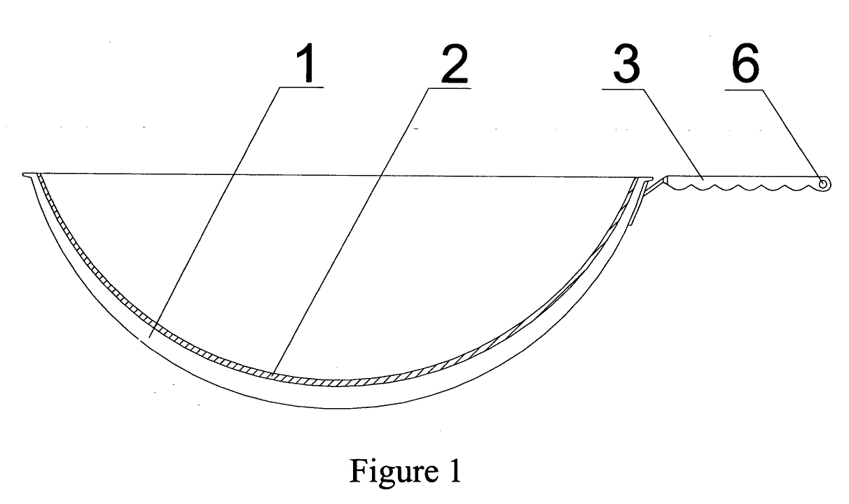

FIG. 1 shows schematically section view for the structure of non-soot pot in the present invention; it comprises a pot body 1, further comprising even thermal layer 2 located on the inner surface of the pot body 1 with the lower thermal conductivity than that of the pot body 1. The key of the invention lies in the thermal conductivity of the even thermal layer 2 lower than that of the pot body 1 so as to achieve heating evenly. The bottom of the pot body 1 is thick with the edge thin. The thickness of the whole pot body 1 is 1-6 mm, while that of the bottom and the edge is 3-6 mm and 1-3 mm respectively. In this embodiment, many kinds of metal and alloy materials, for example gold, silver, copper, magnesium, aluminum or the like, can be used for the pot 1 in which the special gravity of gold is 19.302, special thermal capacity 128 and thermal conductivity 317.9; the special gravity of sliver 10.49, special thermal capacity 235 and thermal conductivity 428; the special gravity of copper 8.93, special thermal capacity 386 and thermal conductivity 398; the special gravity of aluminum 2.6989, special thermal capacity 900 and thermal conductivity 247; the special gravity of magnesium 1.738, special thermal capacity 102.5 and thermal conductivity 155.5. Synthetically taken into account the special gravity, special thermal capacity, thermal conductivity, cost and price factors, aluminum or magnesium alloy material are preferably used. The Zhisha ceramic is preferably used for the even thermal layer 2 which is sintered on the inner surface of aluminum or magnesium alloy. The selected Zhisha is natural Zhisha containing minerals and microelements which are essential for people. Zhisha is of micro-ventilative structure to communicate with natural terra-gas, good heat preservation properties, uniform heating. The nutrition is not undermined and the food is kept with its natural taste. The aluminum or magnesium alloy pot with high thermal conductivity, high thermal efficiency, and thermal storage for long time can save oil and gas. No local high temperature in the pot body, cooking becomes more convenient without stir-fry. The pot body 1 is connected to pot handle 3 fixed thereon. The pot handle 3 facilitates people to hold for cooking. At the end of pot handle 3, there is hanging-hole 6 which is convenient for hanging when not in use. The thermal conductivity of the Zhisha ceramics is lower than that of aluminum and magnesium alloys, so the heat absorbed quickly by the aluminum or magnesium alloy is transferred to the Zhisha ceramic. Due to the lower thermal conductivity of Zhisha ceramic, a part of heat can not be absorbed, but spread around so that the temperature of the entire even thermal layer 2 rises at the same time. The pot provided by the present invention only need a moderate or small fire for cooking which must need a large fire if the original pot is used and also can save energy and eliminate soot.

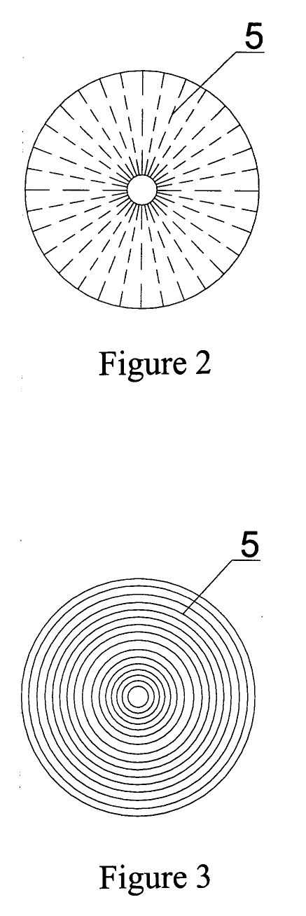

FIG. 2 is a schematic section view of the embodiment 1 for the convexity structure on the even thermal layer of the non-soot pot in the present invention. Some tiny convexity structures 5 are provided on the even thermal layer 2, which are radial convexity. FIG. 3 is a schematic section view of the embodiment 2 for the convexity structure on the even thermal layer of the non-soot pot in the present invention. Some tiny convexity structures 5 are provided on the even thermal layer 2, which are spiral convexity. After heating the air in the cavity between the convexity structures expands so as to separate food from the pot body and achieve the physical nonstick effect. This physical nonstick structure can achieve better nonstick effect than the original chemical coating.

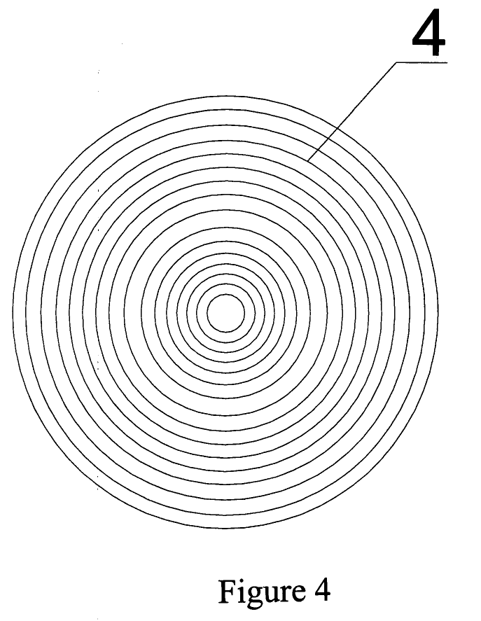

FIG. 4 is a schematic section view for the spiral structure of the non-soot pot external surface in the present invention. The external surface of the pot body is spiral structure 4 which increases the surface area and improves the utilization of energy.

### Embodiment 2

The main difference between the embodiment 1 and the present embodiment is that the aluminum or magnesium alloy material is preferably used for pot body 1, on the inner surface of which the stainless steel is compounded and is preferably used for the even thermal layer 2. The stainless steel with lower thermal conductivity than that of the aluminum or magnesium alloy can also achieve the effect of heating evenly. The heat absorbed quickly by the aluminum or magnesium alloy is transferred to the stainless steel. For the stainless steel with lower thermal conductivity, a part of heat can not be absorbed, but spread around so that the temperature of the entire stainless steel layer rises at the same time.

The above embodiments just explain the present invention and should not be regarded as limitation to the present invention. Any variation and modification based on the invention should fall in the scope of the protection of present invention.

1. A non-soot pot comprising a pot body (1), wherein it further comprises a even thermal layer (2) with lower thermal conductivity than that of pot body (1), the layer is located on the inner surface of the pot body (1).

2. The non-soot pot according to claim 1, wherein the bottom of the pot body (1) is thick and the edge of it is thin.

3. The non-soot pot according to claim 2, wherein the whole pot body (1) is 1-6 mm in thickness, while the bottom is 3-6 mm and the edge is 1-3 mm in thickness respectively.

4. The non-soot pot according to claim 3, wherein the pot body (1) is made of aluminum or magnesium alloy materials, on the inner surface of which the Zhisha ceramic is sintered and used for the even layer (2).

5. The non-soot pot according to claim 3, wherein the pot body (1) is made of aluminum or magnesium alloy materials, on the inner surface of which the stainless steel is compounded and used for the even thermal layer (2).

6. The non-soot pot according to claim 1, wherein a spiral structure (4) is used for the external surface of the pot body (1).

7. The non-soot pot according to claim 1, wherein some tiny convex structures (5) are provided on the even thermal layer (2).

8. The non-soot pot according to claim 6, wherein some tiny convexity structures (5) are provided on the even thermal layer (2).

9. The non-soot pot according to the claim 7, wherein the convex structure (5) is radial convexity or spiral convexity.

10. The non-soot pot according to the claim 8, wherein the convex structure (5) is radial convexity or spiral convexity.

11. The non-soot pot according to claim 2, wherein a spiral structure (4) is used for the external surface of the pot body (1).

12. The non-soot pot according to claim 3, wherein a spiral structure (4) is used for the external surface of the pot body (1).

13. The non-soot pot according to claim 4, wherein a spiral structure (4) is used for the external surface of the pot body (1).

14. The non-soot pot according to claim 5, wherein a spiral structure (4) is used for the external surface of the pot body (1).

15. The non-soot pot according to claim 2, wherein some tiny convex structures (5) are provided on the even thermal layer (2).

16. The non-soot pot according to claim 3, wherein some tiny convex structures (5) are provided on the even thermal layer (2).

17. The non-soot pot according to claim 4, wherein some tiny convex structures (5) are provided on the even thermal layer (2).

18. The non-soot pot according to claim 5, wherein some tiny convex structures (5) are provided on the even thermal layer (2).
